(19) United States
(12) Patent Application Publication
(10) Pub. No.: US 2023/0239268 A1
(43) Pub. Date: Jul. 27, 2023

(54) MANAGING IP ADDRESSES FOR DPDK ENABLED NETWORK INTERFACES FOR CLOUD NATIVE PODS

(71) Applicant: VMware, Inc., Palo Alto, CA (US)

(72) Inventors: Xiaojun Lin, Beijing (CN); Liang Cui, Beijing (CN); Aravind Srinivasan, Sunnyvale, CA (US); Hemanth Kumar Pannem, Danville, CA (US); Wenwu Peng, Beijing (CN); Hailing Xu, Beijing (CN); Xiaoli Tie, Beijing (CN)

(21) Appl. No.: 17/703,844

(22) Filed: Mar. 24, 2022

(30) Foreign Application Priority Data
Jan. 21, 2022 (WO) PCT/CN2022/073222

(51) Int. Cl. H04L 61/5007; H04L 101/668; H04L 61/5038; H04L 67/06

(52) U.S. Cl. CPC H04L 61/2007; H04L 61/6068; H04L 61/2038; H04L 67/06

(57) ABSTRACT

The present disclosure provides example computer-implemented method, medium, and system for managing IP addresses for DPDK enabled network interfaces for cloud native pods. One example method includes creating a pod of one or more containers, where the pod connects to multiple networks through multiple network interfaces. A poll mode driver (PMD) is attached to a first network interface of the multiple network interfaces, where the PMD enables one or more data plane development kit (DPDK) applications inside the pod to manage the first network interface. A first container network interface (CNI) is created to handle the DPDK enabled first network interface. A first Internet protocol (IP) address is allocated to the first network interface using the first CNI. The first IP address is passed to the one or more DPDK applications using the first CNI.

### BACKGROUND

The present disclosure relates to managing the assignment of Internet protocol (IP) addresses for data plane development kit (DPDK) enabled network interfaces for cloud native pods of containers running containerized applications in a container orchestration system. A DPDK typically includes libraries used in telecommunication (hereafter “telco”) applications to accelerate packet processing performance for the data plane. DPDK runs on a wide variety of CPU architectures. One typical use of the DPDK is to offload packet processing from the operating system kernel to processes running in the user space. Conventionally, to use DPDK libraries for the DPDK, a poll mode driver (PMD) is attached to a network interface to replace an original driver for the network interface. After the PMD is attached to the network interface, the network interface is no longer managed by the operating system kernel for network traffic. Instead the network traffic of the network interface is managed by DPDK applications in the user space. This type of network interface may be referred to as DPDK enabled network interfaces.

### SUMMARY

The present disclosure involves computer-implemented method, medium, and system for managing the assignment of IP addresses for DPDK enabled network interfaces for cloud native pods of containers running containerized applications in a container orchestration system. One example computer-implemented method includes creating, in a container orchestration platform, a pod of one or more containers, where the pod is coupled to multiple networks through multiple network interfaces. A poll mode driver (PMD) is attached to a first network interface of the multiple network interfaces, where the PMD enables one or more data plane development kit (DPDK) applications inside the pod to manage the first network interface, and the one or more DPDK applications accelerate packet processing for a data plane in a first network corresponding to the first network interface. A first container network interface (CNI) is created in the container orchestration platform, where the first CNI is configured to handle the DPDK enabled first network interface. A first Internet protocol (IP) address is allocated to the first network interface using the first CNI. The first IP address is passed to the one or more DPDK applications inside the pod using the first CNI.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### DESCRIPTION OF DRAWINGS

FIG. 1 depicts an architecture of an example computer-implemented system.

FIG. 2 illustrates an example network interface management comparison between a first case of a Linux kernel without DPDK and a second case of a Linux kernel with DPDK.

FIG. 3 illustrates an example flow for managing IP of a network interface when attaching the network interface to a pod in a container orchestration platform.

FIG. 4 illustrates an illustrates an example flow for managing IP of a DPDK enabled network interface when attaching the DPDK enabled network interface to a pod in a container orchestration platform.

FIG. 5 illustrates a flow diagram of an example process for managing IP of DPDK enabled network interfaces for cloud native pods.

FIG. 6 is a schematic illustration of an example computer system.

### DETAILED DESCRIPTION

A container orchestration platform enables the automation of much of the operational effort required to run containerized workloads and services. This includes a wide range of functionality used to manage a container's lifecycle, including, but not limited to, provisioning, deployment, scaling (up and down), networking, and load balancing. A container orchestration platform can have multiple pods, with each pod representing a group of one or more application containers, and some shared resources for those containers.

In a cluster of nodes of a container orchestration platform, for example, a Kubernetes cluster, a pod in the container orchestration platform can request multiple network interfaces to connect to different networks. Multiple network attachment may be done by Container Network Interface (CNI) framework in the container orchestration platform. An example CNI for multiple network attachment management in Kubernetes is Multus. Multus can collaborate with other CNIs to allocate IPs and assign routes to network interfaces.

To manage multiple network interfaces, a network attachment definition (NAD) object can be created in the cluster of nodes of the container orchestration platform. This object can define the type of the network interface, the range of IP addresses for the network interface, and the domain name system (DNS) network information. A network interface attached to a pod of the container orchestration platform can reference this object for network management. An example of a NAD object in Kubernetes is shown below.

```
apiVersion : “k8s.cni.cncf.io/v1”
kind: NetworkAttachmentDefinition
metadata:
  name: sriov-openness
  annotations:
    k8s.v1.cni.cncf.io/resourceName: intel.com/intel_sriov_dpdk
spec:
  config: ‘{
  “type”: “sriov”,
  “cniVersion”: “0.3.1”,
  “name”: “sriov-openness-network”,
  “mtu”: 9000,
  “ipam”: {
    “type” : whereabouts s
    “range”: “192.168.2.0/24”
    “routes”: [
      {
        “dst”: “192.168.3.0/24”,
        “gw”: “192.168.2.100”
      }
    ],
    “dns”: {
      “nameservers”: [
        “8.8.8.8”
      ]
    }
  }
}’
```

DPDK enabled network interface may not rely solely on the existing CNIs of a container orchestration platform, such as an IP address management (IPAM) CNI for Kubernetes, for managing IP addresses and routes of the DPDK enabled network interface. When a specific IP address for the DPDK enabled network interface is configured using the DPDK applications inside a pod of the container orchestration platform, this specific IP address or additional routes may be set manually on the environment variables of the pod, and the IP management of the DPDK enabled network interface is done outside the container orchestration platform.

This disclosure describes technologies for managing IP for DPDK enabled network interfaces for cloud native pods. In some implementations, an intermediate CNI is used together with the existing CNIs of a container orchestration platform to enable IP management of a DPDK enabled network interface, when attaching the DPDK enabled network interface to a pod in the container orchestration platform.

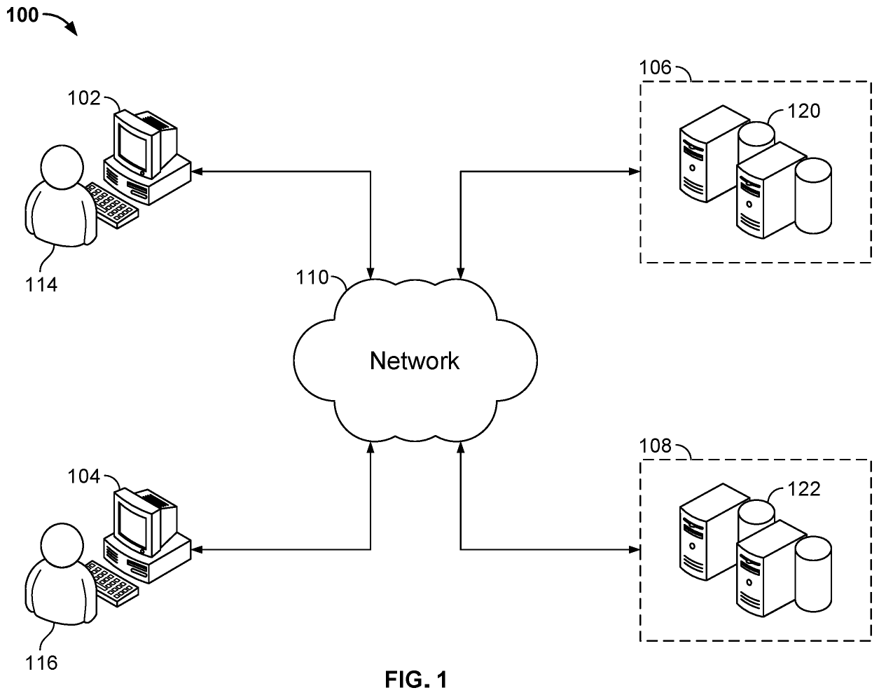

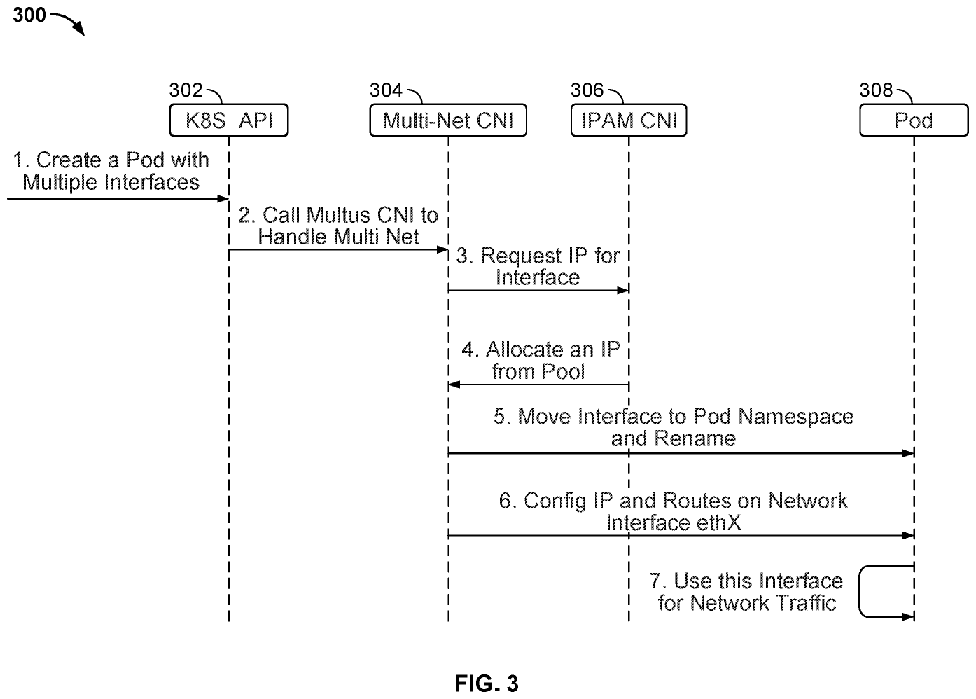

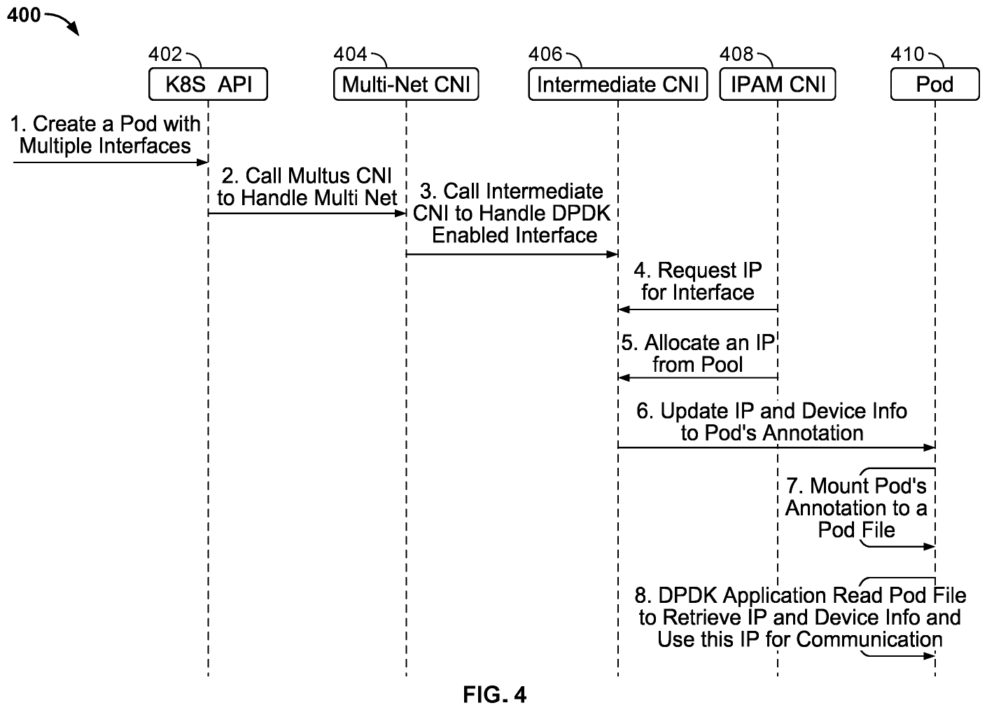

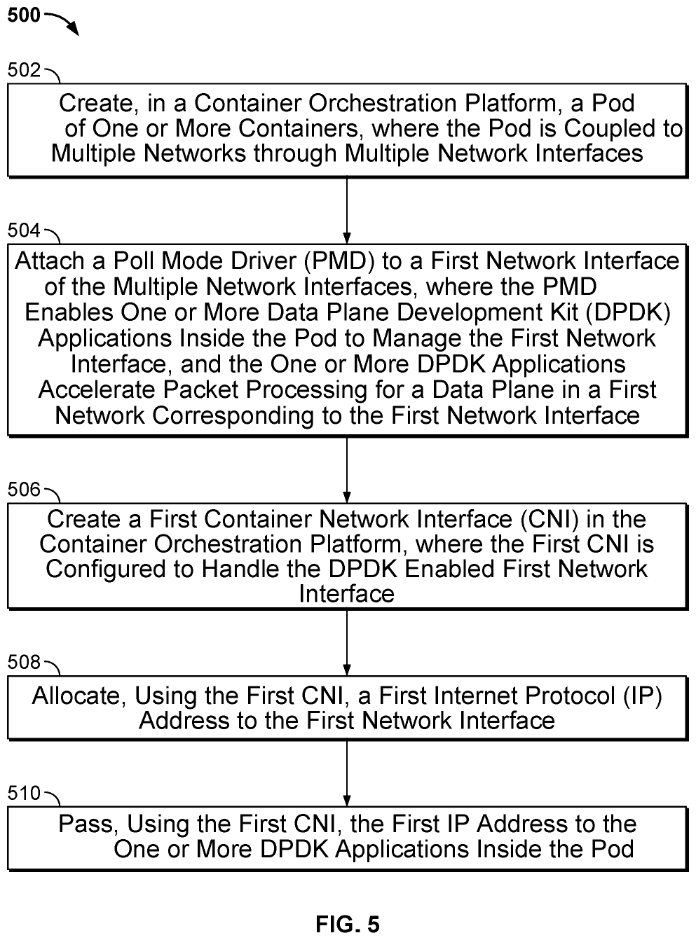

FIG. 1 depicts an architecture of an example computer-implemented system 100. In the depicted example, the example system 100 includes a client device 102, a client device 104, a network 110, and a cloud environment 106 and a cloud environment 108. The cloud environment 106 may include one or more server devices and databases (e.g., processors, memory). In the depicted example, a user 114 interacts with the client device 102, and a user 116 interacts with the client device 104. In some implementations, cloud environments 106 and 108 can be used to implement example flows 300 and 400 in FIG. 3 and FIG. 4, as well as example process 500 in FIG. 5, for managing IP addresses for network interfaces of cloud native pods of containers. Cloud environments 106 and 108 can also be used to implement container orchestration platforms.

In some examples, the client device 102 and/or the client device 104 can communicate with the cloud environment 106 and/or cloud environment 108 over the network 110. The client device 102 can include any appropriate type of computing device, for example, a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the cloud environment 106 includes at least one server and at least one data store 120. Similarly, cloud environment 108 includes at least one server and at least one data store 122. In the example of FIG. 1, the cloud environment 106 is intended to represent various forms of servers including, but not limited to, a web server, an application server, a proxy server, a network server, and/or a server pool. In general, server systems accept requests for application services and provides such services to any number of client devices (e.g., the client device 102 over the network 110).

In accordance with implementations of the present disclosure, and as noted above, the cloud environment 106 can host applications and databases running on host infrastructure. In some instances, the cloud environment 106 can include multiple cluster nodes that can represent physical or virtual machines. A hosted application and/or service can run on VMs hosted on cloud infrastructure. In some instances, one application and/or service can run as multiple application instances on multiple corresponding VMs, where each instance is running on a corresponding VM.

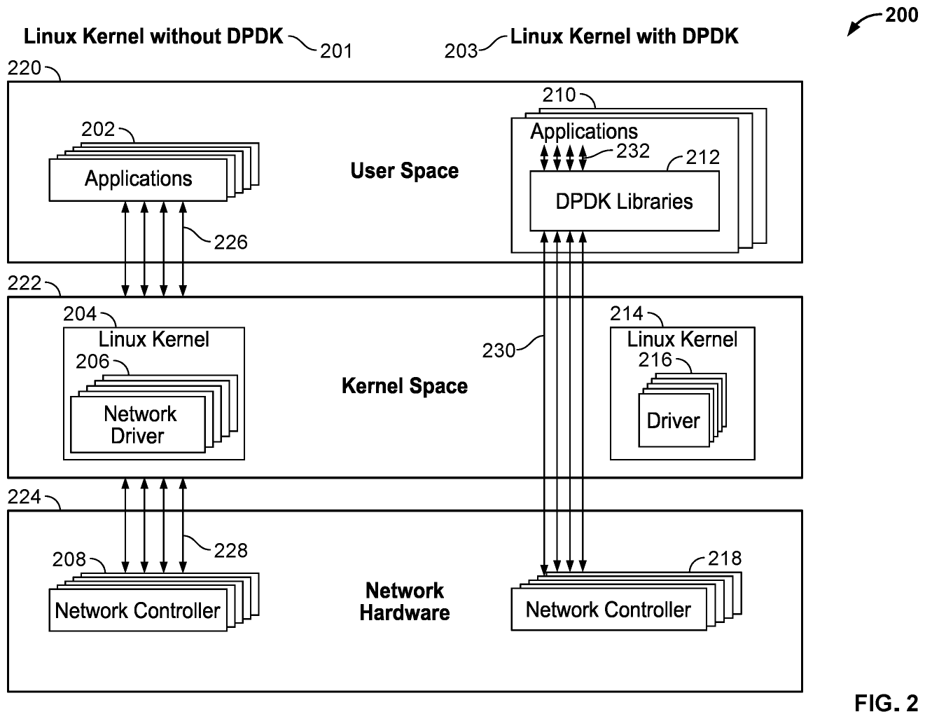

FIG. 2 illustrates an example network interface management comparison 200 between a first case 201 of a first Linux kernel without DPDK and a second case 203 of a second Linux kernel with DPDK. In some implementations, for the first case 201 of the first Linux kernel without DPDK, a network interface can be managed by an operating system kernel such as a first Linux kernel 204 for network traffic, using control 228 that interacts with the first Linux kernel 204. For the second case 203 of the second Linux kernel with DPDK, because DPDK Poll Mode Drivers 216 have been attached to the network interface, the network interface is no longer managed by a second Linux kernel 214 for network traffic. In this scenario, the network interface neither has an interface name nor has any IP or routes associated with the network interface. Therefore the network interface is managed by DPDK applications 210 in user space 220, using controls 230 and 232, where controls 230 and 232 do not interact with the second Linux kernel 214.

In some implementations, for the second case 203, when a pod in a container orchestration system requests to use the network interface, a network interface name may not show up inside the pod. Instead, an identifier of the peripheral component interconnect (PCI) associated with the network device can be put into an environment variable. Then DPDK applications inside the pod can request to control the network interface by the PCI identifier of the network interface.

In some implementations, for the second case 203, unlike a network interface whose IP addresses and routes are managed by a CNI of the container orchestration platform, the DPDK enabled network interface may not leverage existing CNIs of the container orchestration platform, such as IPAM CNI for Kubernetes, for managing IP and routes. When a specific IP for the DPDK enabled network interface is configured using the DPDK applications inside a pod of the container orchestration platform, this specific IP or additional routes are manually set on the environment variables of the pod, and the IP management of the DPDK enabled network interface is done outside of container orchestration platform.

FIG. 3 illustrates an example flow 300 for managing IP of a network interface when attaching the network interface to a pod in a container orchestration platform, where the network interface is managed by an operating system kernel and is not managed by DPDK applications in the pod. Example flow 300 can include the following steps.

Step one: pod 308 is created with multiple network interfaces, using Kubernetes (K8s) API 302.

Step two: multi-net CNI 304, for example, a Multus CNI for Kubernetes, is called by the K8s API 302 for multiple network attachment management.

Step three: multi-net CNI 304 requests IPAM CNI 306 to allocate an IP for the network interface.

Step four: an IP is allocated by IPAM CNI 306 for the network interface and provided by IPAM CNI 306 to multi-net CNI 304.

Step five: multi-net CNI 304 moves network interface to the namespace of pod 308 and renames the network interface.

Step six: multi-net CNI 304 configures the IP and routes on the network interface based on the IP allocated by IPAM CNI 306.

Step seven: pod 308 uses the configured network interface for network traffic.

If the network interface is DPDK enabled, for example, if the network interface is managed by DPDK applications in pod 308, operations from step three through step seven described above may not be carried out, because multi-net CNI 304 may no longer be able to interact with IPAM CNI 306, and the IP and routes of the network interface may not be managed by the container orchestration platform.

FIG. 4 illustrates an example flow 400 for managing IP of a DPDK enabled network interface when attaching the DPDK enabled network interface to a pod in a container orchestration platform. In some implementations, an intermediate CNI 406 is used to enable operations from multi-net CNI 404 to IPAM CNI 408 and to pod 410. Example flow 400 can include the following steps.

Step one: pod 410 is created with multiple network interfaces, using K8s API 402.

Step two: multi-net CNI 404, for example, a Multus CNI for Kubernetes, is called by the Kubernetes API 402 for multiple network attachment management.

Step three: intermediate CNI 406 is called by multi-net CNI 404 to handle the DPDK enabled network interface.

Step four: intermediate CNI 406 requests IPAM CNI 408 to allocate an IP for the DPDK enabled network interface.

Step five: an IP is allocated by IPAM CNI 408 for the DPDK enabled network interface and provided by IPAM CNI 408 to intermediate CNI 406.

Step six: intermediate CNI 406 updates the IP and device information in the annotation of pod 410 based on the IP allocated by IPAM CNI 408.

Step seven: intermediate CNI 406 mounts the annotation of pod 410 to a file of pod 410.

Step eight: DPDK applications in pod 410 read the file of pod 410 to retrieve the IP and device information and use the retrieved IP for communication.

In some implementations, intermediate CNI 406 can interact with IPAM CNI 408 to get an allocated IP and can put the information of the allocated IP into the annotation of pod 410, as shown in the lines in bold text below.

| | |
|---|---|
| vagrant@ubuntu: | ~$ kubectl describe pod tp |
| Name: | tp |
| Namespace: | default |
| Priority: | 0 |
| Node: | ubuntu/10.155.20.59 |
| Start Time: | Wed, 31 Mar 2021 08:14:43 +0000 |
| Labels: | <none> |
| Annotations: | cni.projectcalico.org/podIP: 192.168.243.209/32 |
| | cni.projectcalico.org/podIPs: 192,168.243.209/32 |
| | k8s.v1.cni.cncf.io/network-status: |
| | [{ |
| | “name”: “kBs-pod-network”, |
| | “ips”: [ |
| | “192.168.243.209” |
| | ], |
| | “default”: true, |
| | “dns”: { } |
| | },{ |
| | “name”: “sriov-openness-network”, |
| | “interface”: “net1“, |
| | “ips”: [ |
| | “192.168.2.1/24” |
| | ], |
| | “dns”: { |
| | “nameservers”: [ |
| | “8.8.8.8” |
| | ] |
| | }, |
| | “mtu”: 9000, |
| | “routes”: [ |
| | { |
| | “dst”: “192.168.3.0/24”, |
| | “gw”: “192.168.2.100” |
| | } |
| | ], |
| | “mac”: “00:0c:29:76:8a:dd”, |
| | “pciBusID”: “0000:03:00.0” |
| | }] |
| | k8s.v1.cni.cncf.io/networks: sriov-openness |
| ....... | |

In the definition of pod 410, an API in the container orchestration platform, such as Kubernetes downward API, can be leveraged to mount the annotation of pod 410 into the file of pod 410. Consequently the DPDK application inside pod 410 can read the information of the allocated IP in the annotation of pod 410 and set up DPDK enabled network interface accordingly.

An example of the definition of pod 410 is shown below. It uses Kubernetes downward API to mount the annotation of pod 410 to pod 410's file /etc/podinfo/annotations, as shown in the lines in bold text below.

```
vagrant@ubuntu:~$ cat pod.yaml
~ ~ ~
apiversion: v1
kind: Pod
metadata:
  name: tp
  annotations:
    k8s.v1.cni.cncf.io/networks: sriov-openness
spec:
  containers:
  ~ name: samplepod
    command: [“/bin/bash”, “~c”, “trap : TERM INT; sleep infinity &
wait”]
    image: vmwtec.jfrog.io/docker-proxy/dougbtv/centos-network
    ports:
    ~ containerPort: 80
    volumeMounts:
    ~ name: podinfo
      mountPath: /etc/podinfo
    resources:
      requests:
        intel.com/intel_sriov_dpdk: ‘1’
      limits:
        intel.com/intel_sriov_dpdk: ‘1’
  volumes:
  ~ name: podinfo
    downwardAPI:
      items:
      ~ path: “labels”
        fieldRef:
          fieldPath: metadata.labels
      ~ path: “annotations”
        fieldRef:
            fieldPath: metadata.annotations
```

FIG. 5 illustrates a flow diagram 500 of an example process for managing IP for DPDK enabled network interfaces for cloud native pods. For convenience, the process 500 will be described as being performed by a system of one or more computers, located in one or more locations, and programmed appropriately in accordance with this specification. For example, server devices in cloud environment 106 in example system 100 of FIG. 1, appropriately programmed, can perform the process 500.

At 502, a computer system creates, in a container orchestration platform, a pod of one or more containers, where the pod is coupled to multiple networks through multiple network interfaces.

At 504, the computer system attaches a poll mode driver (PMD) to a first network interface of the multiple network interfaces, where the PMD enables one or more data plane development kit (DPDK) applications inside the pod to manage the first network interface, and the one or more DPDK applications accelerate packet processing for a data plane in a first network corresponding to the first network interface.

At 506, the computer system creates a first container network interface (CNI) in the container orchestration platform, where the first CNI is configured to handle the DPDK enabled first network interface.

At 508, the computer system allocates, using the first CNI, a first Internet protocol (IP) address to the first network interface.

At 510, the computer system passes, using the first CNI, the first IP address to the one or more DPDK applications inside the pod.

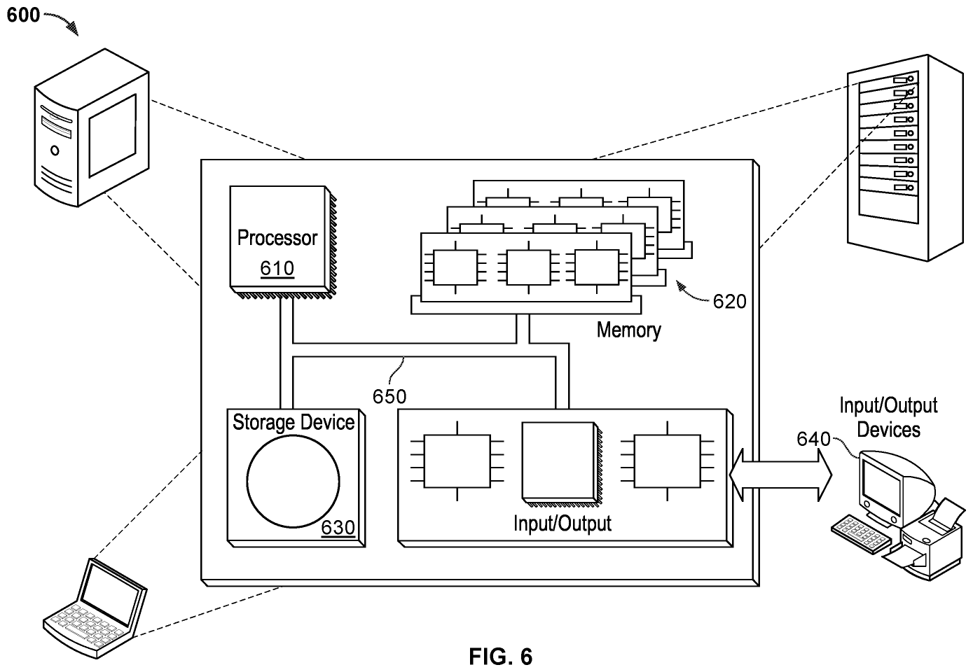

FIG. 6 is a schematic illustration of an example computing system 600. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, and 640 are interconnected using a system bus 650. The processor 610 is capable of processing instructions for execution within the system 600. In some implementations, the processor 610 is a single-threaded processor. The processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. The memory 620 is a volatile memory unit. The memory 620 is a non-volatile memory unit. The storage device 630 is capable of providing mass storage for the system 600. The storage device 630 is a computer-readable medium. The storage device 630 may be a floppy disk device, a hard disk device, an optical disk device, or a tape device. The input/output device 640 provides input/output operations for the system 600. The input/output device 640 includes a keyboard and/or pointing device. The input/output device 640 includes a display unit for displaying graphical user interfaces.

Certain aspects of the subject matter described here can be implemented as a method. A pod of one or more containers is created in a container orchestration platform, where the pod is coupled to multiple networks through multiple network interfaces. A poll mode driver (PMD) is attached to a first network interface of the multiple network interfaces. The PMD enables one or more data plane development kit (DPDK) applications inside the pod to manage the first network interface. The one or more DPDK applications accelerate packet processing for a data plane in a first network corresponding to the first network interface. A first container network interface (CNI) is created in the container orchestration platform, where the first CNI is configured to handle the DPDK enabled first network interface. A first Internet protocol (IP) address is allocated to the first network interface using the first CNI. The first IP address is passed to the one or more DPDK applications inside the pod using the first CNI.

An aspect taken alone or combinable with any other aspect includes the following features. The allocating the first IP address to the first network interface using the first CNI includes transmitting, from the first CNI and to an internet protocol address management (IPAM) CNI in the container orchestration platform, a request for a first IP address for the first network interface; and receiving, by the first CNI and from the IPAM CNI, the first IP address for the first network interface.

An aspect taken alone or combinable with any other aspect includes the following features. After creating the pod and before allocating the first IP address to the first network interface, invoking a multi-network CNI in the container orchestration platform to manage the multiple networks for the pod.

An aspect taken alone or combinable with any other aspect includes the following features. The passing the first IP address to the one or more DPDK applications inside the pod using the first CNI includes updating, using the first CNI and in an annotation of the pod, IP address information of the first network interface using the first IP address; and mounting the annotation of the pod to a pod file associated with the pod, where the pod file is used by the one or more DPDK applications for communication based on the first IP address.

An aspect taken alone or combinable with any other aspect includes the following features. After mounting the annotation of the pod to the pod file associated with the pod, configuring, by the one or more DPDK applications inside the pod, the first network interface using the first IP address in the pod file.

An aspect taken alone or combinable with any other aspect includes the following features. The annotation of the pod corresponds to a network attachment definition (NAD) object associated with a cluster of nodes in the container orchestration platform.

An aspect taken alone or combinable with any other aspect includes the following features. The first network interface references the NAD object for network management.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method operations can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a cathode ray tube (CRT) or liquid crystal display (LCD) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other operations may be provided, or operations may be eliminated, from the described flows, and other components may be added to, or removed from, the described systems. Accordingly, other implementations are within the scope of the following claims.

The preceding figures and accompanying description illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain implementations and generally associated methods, alterations and permutations of these implementations and methods will be apparent to those skilled in the art. Accordingly, the above description of example implementations does not define or constrain this disclosure. Other changes, substitutions, and alterations are also possible without departing from the spirit and scope of this disclosure.

What is claimed is:

1. A computer-implemented method, comprising:
creating, in a container orchestration platform, a pod of one or more containers, wherein the pod is coupled to a plurality of networks through a plurality of network interfaces;
attaching a poll mode driver (PMD) to a first network interface of the plurality of network interfaces, wherein the PMD enables one or more data plane development kit (DPDK) applications inside the pod to manage the first network interface, and wherein the one or more DPDK applications accelerate packet processing for a data plane in a first network corresponding to the first network interface;
creating a first container network interface (CNI) in the container orchestration platform, wherein the first CNI is configured to handle the DPDK enabled first network interface;
allocating, using the first CNI, a first Internet protocol (IP) address to the first network interface; and
passing, using the first CNI, the first IP address to the one or more DPDK applications inside the pod.

2. The computer-implemented method according to claim 1, wherein allocating, using the first CNI, the first IP address to the first network interface comprises:
transmitting, from the first CNI and to an internet protocol address management (IPAM) CNI in the container orchestration platform, a request for a first IP address for the first network interface; and
receiving, by the first CNI and from the IPAM CNI, the first IP address for the first network interface.

3. The computer-implemented method according to claim 1, further comprising:
after creating the pod and before allocating the first IP address to the first network interface, invoking a multi-network CNI in the container orchestration platform to manage the plurality of networks for the pod.

4. The computer-implemented method according to claim 1, wherein passing, using the first CNI, the first IP address to the one or more DPDK applications inside the pod comprises:
updating, using the first CNI and in an annotation of the pod, IP address information of the first network interface using the first IP address; and
mounting the annotation of the pod to a pod file associated with the pod, wherein the pod file is used by the one or more DPDK applications for communication based on the first IP address.

5. The computer-implemented method according to claim 4, further comprising:
after mounting the annotation of the pod to the pod file associated with the pod, configuring, by the one or more DPDK applications inside the pod, the first network interface using the first IP address in the pod file.

6. The computer-implemented method according to claim 4, wherein the annotation of the pod corresponds to a network attachment definition (NAD) object associated with a cluster of nodes in the container orchestration platform.

7. The computer-implemented method according to claim 6, wherein the first network interface references the NAD object for network management.

8. A non-transitory, computer-readable medium storing one or more instructions executable by a computer system to perform operations, the operations comprising:
creating, in a container orchestration platform, a pod of one or more containers, wherein the pod is coupled to a plurality of networks through a plurality of network interfaces;
attaching a poll mode driver (PMD) to a first network interface of the plurality of network interfaces, wherein the PMD enables one or more data plane development kit (DPDK) applications inside the pod to manage the first network interface, and wherein the one or more DPDK applications accelerate packet processing for a data plane in a first network corresponding to the first network interface;
creating a first container network interface (CNI) in the container orchestration platform, wherein the first CNI is configured to handle the DPDK enabled first network interface;
allocating, using the first CNI, a first Internet protocol (IP) address to the first network interface; and
passing, using the first CNI, the first IP address to the one or more DPDK applications inside the pod.

9. The non-transitory, computer-readable medium according to claim 8, wherein allocating, using the first CNI, the first IP address to the first network interface comprises:
transmitting, from the first CNI and to an internet protocol address management (IPAM) CNI in the container orchestration platform, a request for a first IP address for the first network interface; and
receiving, by the first CNI and from the IPAM CNI, the first IP address for the first network interface.

10. The non-transitory, computer-readable medium according to claim 8, further comprising:
after creating the pod and before allocating the first IP address to the first network interface, invoking a multi-network CNI in the container orchestration platform to manage the plurality of networks for the pod.

11. The non-transitory, computer-readable medium according to claim 8, wherein passing, using the first CNI, the first IP address to the one or more DPDK applications inside the pod comprises:
updating, using the first CNI and in an annotation of the pod, IP address information of the first network interface using the first IP address; and
mounting the annotation of the pod to a pod file associated with the pod, wherein the pod file is used by the one or more DPDK applications for communication based on the first IP address.

12. The non-transitory, computer-readable medium according to claim 11, further comprising:
after mounting the annotation of the pod to the pod file associated with the pod, configuring, by the one or more DPDK applications inside the pod, the first network interface using the first IP address in the pod file.

13. The non-transitory, computer-readable medium according to claim 11, wherein the annotation of the pod corresponds to a network attachment definition (NAD) object associated with a cluster of nodes in the container orchestration platform.

14. The non-transitory, computer-readable medium according to claim 13, wherein the first network interface references the NAD object for network management.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, the one or more operations comprising:
creating, in a container orchestration platform, a pod of one or more containers, wherein the pod is coupled to a plurality of networks through a plurality of network interfaces;
attaching a poll mode driver (PMD) to a first network interface of the plurality of network interfaces, wherein the PMD enables one or more data plane development kit (DPDK) applications inside the pod to manage the first network interface, and wherein the one or more DPDK applications accelerate packet processing for a data plane in a first network corresponding to the first network interface;
creating a first container network interface (CNI) in the container orchestration platform, wherein the first CNI is configured to handle the DPDK enabled first network interface;
allocating, using the first CNI, a first Internet protocol (IP) address to the first network interface; and
passing, using the first CNI, the first IP address to the one or more DPDK applications inside the pod.

16. The computer-implemented system according to claim 15, wherein allocating, using the first CNI, the first IP address to the first network interface comprises:
transmitting, from the first CNI and to an internet protocol address management (IPAM) CNI in the container orchestration platform, a request for a first IP address for the first network interface; and
receiving, by the first CNI and from the IPAM CNI, the first IP address for the first network interface.

17. The computer-implemented system according to claim 15, further comprising:
after creating the pod and before allocating the first IP address to the first network interface, invoking a multi-network CNI in the container orchestration platform to manage the plurality of networks for the pod.

18. The computer-implemented system according to claim 15, wherein passing, using the first CNI, the first IP address to the one or more DPDK applications inside the pod comprises:
updating, using the first CNI and in an annotation of the pod, IP address information of the first network interface using the first IP address; and
mounting the annotation of the pod to a pod file associated with the pod, wherein the pod file is used by the one or more DPDK applications for communication based on the first IP address.

19. The computer-implemented system according to claim 18, further comprising:
after mounting the annotation of the pod to the pod file associated with the pod, configuring, by the one or more DPDK applications inside the pod, the first network interface using the first IP address in the pod file.

20. The computer-implemented system according to claim 18, wherein the annotation of the pod corresponds to a network attachment definition (NAD) object associated with a cluster of nodes in the container orchestration platform.
